(19) United States
(12) Patent Application Publication
(10) Pub. No.: US 2019/0259553 A1
(43) Pub. Date: Aug. 22, 2019

(54) High-Voltage Switching Device and Switchgear Comprising a High-Voltage Switching Device and Method for Producing a High-Voltage Switching Device

(71) Applicant: Rail Power Systems GmbH, München (DE)

(72) Inventor: Edenilson De Oliveira Hillmann, Bottrop (DE)

(21) Appl. No.: 16/333,633

(22) PCT Filed: Sep. 18, 2017
(86) PCT No.: PCT/EP2017/073517

§ 371 Date: Mar. 15, 2019

(30) Foreign Application Priority Data
Sep. 20, 2016 (EP) 16189599.0

(51) Int. Cl. H01H 33/662

(52) U.S. Cl. CPC H01H 33/66207; H01H 2033/6623; H01H 33/66238

(57) ABSTRACT

The invention relates to a high-voltage switching device, comprising a vacuum interrupting chamber and a switchgear that comprises a high-voltage switching device. Furthermore, the invention relates to a method for producing a high-voltage switching device having a vacuum interrupting chamber. The high-voltage switching device comprises a housing body 1, in which a vacuum interrupting chamber 2 is provided. The vacuum interrupting chamber 2 comprises an immoveable switching contact element 4 and a switching contact element 5 that can move in the axial direction, the moveable switching contact element 5 extending out of the vacuum interrupting chamber 2 and being connected to an actuator 8, which can move in the axial direction, by means of an insulating body 7. The conductor parts 12, 13, 14 that form the current path are connected to the immoveable switching contact element 4 and the moveable switching contact element 5. In the high-voltage switching device according to the invention, a cavity 22 that is filled with an insulating liquid is made in the housing body 1, the moveable switching contact element 5 extending out of the vacuum interrupting chamber 2 and into the cavity 22, and the actuator 8 in turn extending out of the cavity 22 filled with insulating liquid. The high-voltage switching device is characterised in that a sealing arrangement 10 that seals the actuator 8 with respect to the housing body 1 is provided in the cavity 22 that is filled with insulating liquid. As a result, secure disconnection of the load current and the short-circuit current is achieved together with a relatively short insulation distance. Consequently, the high-voltage switching device can be compact.

The invention relates to a high-voltage switching device comprising a vacuum interrupting chamber and to a switchgear comprising a high-voltage switching device. The invention also relates to a method for producing a high-voltage switching device comprising a vacuum interrupting chamber.

Switchgears are used in networks consisting of electrical power lines in order to distribute the electrical power. Switchgears comprise switching devices, which establish or disconnect an electrically conductive connection between electrical contacts. In high-voltage or medium-voltage grids, high-voltage switching devices are used that meet the electrical demands placed on the high voltages in high-voltage and medium-voltage grids. The voltages of the high-voltage grids are generally higher than 52 kV and the voltages of the medium-voltage grids are generally between 1 kV and 52 kV.

High-voltage switching devices are known that comprise a vacuum interrupting chamber in which the electrical contacts are arranged. However, switching devices are also known in which the electrical contacts are arranged in a gas atmosphere consisting of insulation gas, for example SF₆. In contrast to chambers filled with insulating gas, the use of vacuum interrupting chambers is advantageous in that load currents and short-circuit currents can be disconnected inside a relatively small volume, without the risk of emitting hot switching gases. In air-insulated switching devices, a particularly long insulation distance is required, and therefore these switching devices require a particularly large amount of space.

Switching devices comprising vacuum interrupting chambers are known from DE 31 12 776 A1 and DE 40 27 723 A1, for example. The known vacuum interrupting chambers comprise an immoveable contact element, which comprises a contact, and a contact element that can move in the axial direction of the vacuum interrupting chamber and comprises a contact that extends out of the vacuum interrupting chamber. The conductor parts that form the current path are connected to the contact elements. The moveable contact element is actuated by an actuator that is sealed with respect to the housing body of the switching device. The actuator can be driven by an electric drive unit.

The object of the invention is to provide a high-voltage switching device which requires an insulation distance to be formed that is only relatively short, and is therefore more compact when compared with the prior art. In addition, the object of the invention is to provide switchgear which is characterised by a particularly compact design. Another object of the invention is to provide a method by means of which a high-voltage switching device having a particularly compact design is simple and cost-effective to produce.

These objects are achieved according to the invention by the features of the independent claims. The dependent claims relate to preferred embodiments of the invention.

The high-voltage switching device according to the invention comprises a housing body consisting of one or more parts and in which a vacuum interrupting chamber is provided. The vacuum interrupting chamber comprises an immoveable switching contact element and a switching contact element that can move in the axial direction, the moveable switching contact element extending out of the vacuum interrupting chamber and being connected to an actuator, which can move in the axial direction, by means of an insulating body. The conductor parts that form the current path are connected to the immoveable switching contact element and the moveable switching contact element.

An actuator is understood to mean every means that can be used to axially displace the moveable switching contact element in order to close or open the contacts. The actuator can consist of one or more parts. In the high-voltage switching device according to the invention, a cavity that is filled with an insulating liquid is made in the housing, the moveable switching contact element extending out of the vacuum chamber and into the cavity and the actuator in turn extending out of the cavity filled with insulating liquid. The high-voltage switching device is characterised in that a sealing arrangement that seals the actuator with respect to the housing body is provided in the cavity that is filled with insulating liquid. As a result, secure disconnection of the load current and the short-circuit current is achieved together with a relatively short insulation distance. Consequently, the high-voltage switching device can be compact.

A sealing arrangement is understood to mean every means that can be used to form a liquid-tight seal with respect to the housing body or parts of the housing body. The arrangement of the sealing arrangement inside the cavity is understood to mean that at least the parts of the sealing arrangement that form an assembly essential for the seal are arranged inside the cavity. This does not rule out the possibility of individual parts associated with the sealing arrangement also being arranged outside the cavity, for example having a surface that faces outwards.

A preferred embodiment of the high-voltage switching device provides that the sealing arrangement comprises a bellows that is arranged in the cavity and surrounds the actuator that extends out of the liquid-filled chamber in order to seal the actuator with respect to the housing body. Since the bellows is a component of the sealing arrangement that takes up a relatively large amount of space, the switching device is more compact than a switching device in which a bellows is arranged outside a chamber filled with insulating liquid or an insulation gas for sealing purposes. Such a switching device is known from DE 31 13 776 A1, for example.

The bellows can be connected to earth potential. Since the bellows is not arranged in an air-filled space but inside the chamber filled with insulating liquid, the risk of a flashover of parts of the switching device that are connected to a high potential is reduced. Therefore, the high-voltage switching device can be compact.

A particularly preferred embodiment provides that the cavity is closed by means of a cover that is sealed with respect to the housing body, for example by means of a removable plate, one end of the bellows being sealed in a liquid-tight manner with respect to the cover. Closure of the cavity by means of a cover is advantageous for the production of the high-voltage switching device.

Another essential aspect of the invention that is of inventive significance on its own is that the housing body comprises a plastics body that surrounds the liquid-filled cavity at least in part. The plastics body can consist of one or more plastics elements that are interconnected.

The plastics body advantageously consists of a plurality of plastics elements that can be produced simply and cost-effectively by means of injection moulding and can then be connected to one another. Individual plastics elements can be inserted into one another and/or stuck together or welded to one another.

The use of a plastics body makes it possible not only to improve the electrical properties of the switching device, but also to simplify the production thereof. Corners and edges of the live conductor parts of the switching device, which parts are inside the plastics body or the plastics elements, for example a moveable conductor part that is electrically connected to the moveable contact element, produce a highly inhomogeneous electrical field. In order to improve the electrical properties, the plastics elements can have rounded corners and edges and be made of an electrically conductive plastics material, preferably can be mixed with a conductive material, for example carbon. These plastics elements can assume the same potential as the live components. As a result, the electrical field becomes more homogeneous towards the outside, and therefore field control takes place.

The housing body preferably comprises a casting body, which surrounds the vacuum interrupting chamber and the plastics body, at least in part. Since the plastics elements assume the same potential as the live components, the outer shell of the housing body that is made of a casting compound, for example casting resin, is subjected to a smaller amount of load.

A particularly preferred embodiment of the plastics body comprises a first bowl-shaped plastics element and a second bowl-shaped plastics element, the conductor parts that form the current path comprising a moveable conductor part, which is electrically connected to the moveable contact element. The moveable conductor part is arranged in the cavity and is surrounded by the first and second plastics element at least in part. In this embodiment, the corners and edges of the plastics body that surrounds the moveable conductor part or the corners and edges of the plastics elements of said plastics body are rounded, and the plastics body or the plastics elements are made of an electrically conductive plastics material so that they can assume the same potential as the moveable conductor part.

In another particularly preferred embodiment, the plastics body comprises a cylindrical plastics element, which surrounds the sealing arrangement, at least in part. This plastics element is preferably not conductive and therefore cannot carry a potential. The plastics element can ensure that potential-carrying components and the actuator, which is connected to earth potential, are insulated from one another. The plastics element preferably comprises ribs in order to increase the creepage distance.

In order to produce the housing body of the switching device in a simplified manner by means of injection moulding, the plastics body is sealed with respect to the vacuum interrupting chamber so that casting resin cannot enter a gap between the plastics body and the vacuum interrupting chamber. Cutting edges are preferably provided on the plastics body, the housing body of the vacuum interrupting chamber, which housing body can be made of metal or ceramic materials, being surrounded, at least in part, by a material into which the cutting edges can cut when the components are assembled.

The switchgear according to the invention comprises one or more switching devices according to the invention.

The method according to the invention can be used to produce a high-voltage switching device in a simple and cost-effective manner, in which the moveable switching contact element extends out of the vacuum interrupting chamber and into a cavity that is filled with an insulating liquid. The plastics elements of the plastics body are used to prevent the casting compound entering the volume surrounded by the plastics elements during casting, for example with epoxy resin. This ensures that the components inside the plastics elements remain moveable. Since pressures of more than 1 bar may occur during casting, the plastics elements must be mechanically strong. In order to prevent casting resin from being able to enter at the boundary surfaces of the plastics elements, said plastics elements can be inserted into one another and/or stuck together or welded to one another.

In order to produce the high-voltage switching device according to the invention, a casting mould is provided, the shape and dimensions of which correspond to the contour of the housing body of the switching device. The vacuum interrupting chamber and the plastics body or the plastics elements are placed in the casting mould. These plastics elements then form part of the casting mould. The shape and dimensions of the plastics elements therefore determine the shape and dimensions of the housing body, in particular the parts of the housing body in which the vacuum interrupting chamber is arranged and in which the chamber to be filled with insulating liquid is formed.

The space between the wall of the casting mould and the vacuum interrupting chamber and the plastics body is then cast with a casting compound to produce a casting body that surrounds the vacuum interrupting chamber and the plastics body and in which there remains a cavity that is surrounded by the plastics body.

The actuator and the insulating body and the sealing arrangement and, where necessary, additional components are then inserted into the cavity of the switching device and the cavity is filled with the insulating liquid, the cavity being closed by means of a cover that is sealed with respect to the casting body or the plastics body. The cover is preferably sealed with respect to the plastics body.

One embodiment of the invention will be explained in more detail in the following with reference to the drawings, in which

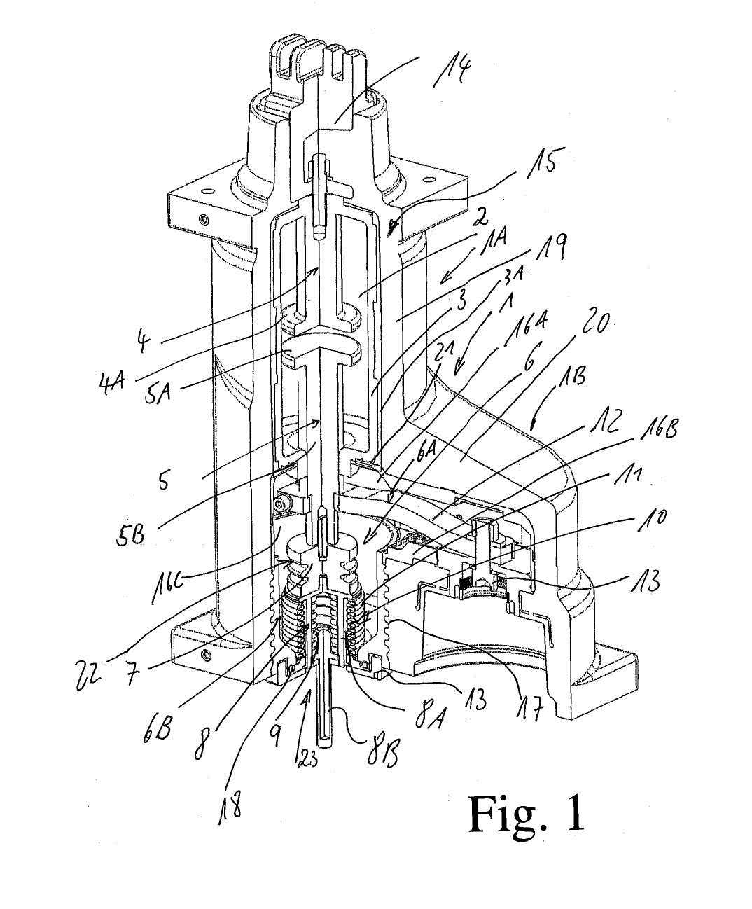

FIG. 1 is a partially sectional perspective view of one embodiment of the high-voltage switching device according to the invention, and

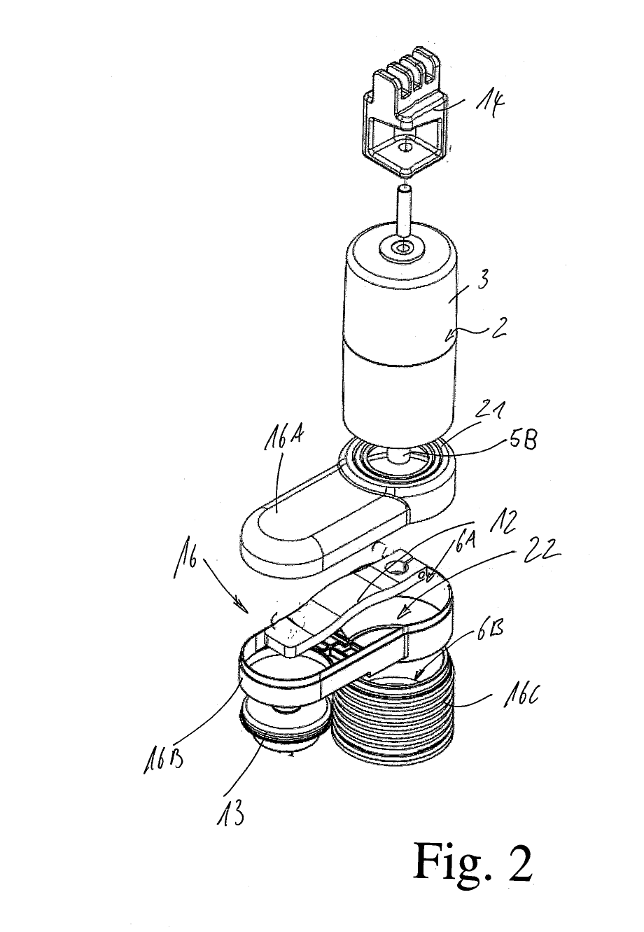

FIG. 2 is an exploded view of individual components of the high-voltage switching device according to the invention.

FIG. 1 shows the components of the high-voltage switching device that are essential to the invention, whilst FIG. 2 is merely an exploded view of individual components of the switching device. Corresponding parts are provided with the same reference numerals in the drawings.

The high-voltage switching device comprises a housing body 1, which consists of a plurality of parts or components and has a housing half 1A which is the upper housing half in the normal installation position and a lower housing half 1B. A vacuum interrupting chamber 2 having a cylindrical housing 3, which housing receives an upper, fixed switching contact element 4 and a lower, moveable switching contact element 5, is arranged in the upper housing half 1A. Both switching contact elements 4, 5 comprise disc-shaped contacts 4A, 5A, which are arranged inside the housing 3 of the vacuum interrupting chamber 2. By closing or opening the contacts 4A, 5A, the current path can be closed or disconnected, i.e. the load current and the short-circuit current can be switched.

A chamber 6 is formed in the lower housing half 1B, which chamber is filled with an insulating liquid. The switching contact element 5 that can be displaced in the axial direction of the vacuum interrupting chamber 2 comprises a shaft 5B, which extends out of the vacuum interrupting chamber and into the chamber 6 filled with insulating liquid. The shaft 5B of the moveable switching contact element 5 is sealed with respect to the housing 3 of the vacuum interrupting chamber 2 in a vacuum-tight manner by means of a sealing arrangement (not shown). The lower end of the shaft 5B is connected, by means of an insulating body 7, to an actuator 8 that extends out of the liquid-filled chamber. By actuating the actuator 8, the moveable switching contact element 5 can be axially displaced such that the contacts 4A, 5A are closed or opened.

The actuator 8 comprises an upper, hollow-cylindrical portion 8A, which is arranged in the chamber 6, and a lower, pin-shaped portion 8B, which is guided so as to be displaceable in the longitudinal direction in the cylindrical space of the upper portion and extends out of the chamber 6. In this case, the upper end of the lower portion 8B is supported on a compression spring 9 in the cylindrical space of the upper portion 8A. When the lower portion 8B is displaced, the upper portion 8A is also displaced such that the moveable switching contact element 5 is axially displaced. The compression spring 9 is used to dampen the impacts when the actuator 8 is actuated. The actuator 8 is driven by a drive unit (not shown), that displaces the lower portion 8B in the axial direction.

The actuator 8 is sealed in a liquid-tight manner with respect to the housing body 1 by means of a sealing arrangement 10. The sealing arrangement 10 comprises a bellows 11, which surrounds the upper portion 8A of the actuator 8, the upper end of the bellows 11 being connected to the upper portion 8A of the actuator 8 in a liquid-tight manner. The lower end of the bellows 11 is sealed with respect to the housing body 1 in a liquid-tight manner. The bellows 11 and the actuator 8 are connected to earth potential. The housing body 1 comprises an opening 23 on the bottom thereof, which is closed in a liquid-tight manner by a cover 13.

In the installation position, the liquid-filled chamber 6 comprises an upper and a lower chamber half 6A, 6B. A moveable conductor part 12, for example a copper band, which is connected to the shaft 5B of the moveable switching contact element 5 is arranged in the upper chamber half 6A. The moveable conductor part 12 is electrically connected to additional conductor parts 13 which form the current path; however, said parts are shown only in part. The fixed switching contact element 4 is also connected to additional conductor parts 14 (only shown in part), which are likewise inserted into the housing body 1 or placed on the housing body.

The housing body 1 comprises a casting body 15, which surrounds the vacuum interrupting chamber 2 and the liquid-filled chamber 6. The casting body 1A forms the outer shell of the housing body 1. The casting compound can be an epoxy resin.

In the lower housing half 1B, a plastics body 16 composed of a plurality of plastics elements 16A, 16B, 16C sits in the casting body 15. FIG. 2 is an exploded view of the plastics elements 16A, 16B, 16C.

The plastics body 16 comprises an upper, bowl-shaped plastics element 16A and a lower, bowl-shaped plastics element 16B in the upper chamber half 6A, which elements surround the moveable conductor part 12, and comprises a cylindrical plastics element 16C in the lower chamber half 6B, which cylindrical plastics element surrounds the bellows 11. The plastics elements 16A, 16B, 16C are designed such that they can be suitably composed. They are sealingly inserted into one another and/or sealingly stuck together or welded to one another. All the plastics elements 16A, 16B, 16C have rounded corners or edges.

The two plastics elements 16A, 16B in the upper chamber half 6A are made of an electrically conductive plastics material, for example the plastics material can be mixed with conductive carbon. Since these plastics elements 16A, 16B can assume the same potential as the moveable conductor part 12 or other conductor parts in the chamber, the electrical field becomes more homogenous towards the outside.

The plastics element 16C in the lower chamber half 6B, which element is not made of a conductive plastics material, cannot carry a potential. This plastics element 6C is used to securely insulate live parts in the chamber 6 with respect to the actuator 8 that connected to earth potential. In order to increase the creepage distance, the plastics element 16C comprises ribs 17 on the outside thereof.

The cover 13 of the housing body 1, which seals the liquid-filled chamber 6, is sealed in a liquid-tight manner with respect to the cylindrical plastics part 16C by means of a sealing ring 18 that is arranged between the cover and the plastics part. The method according to the invention for producing the high-voltage switching device will be described in the following.

In order to produce the switching device, a casting mould (not shown in the drawings) is used, which is designed so as to correspond to the shape and dimensions of the housing body 1 of the switching device and the shape and dimensions of the vacuum interrupting chamber 2 and of the rest of the components of the switching device. The vacuum interrupting chamber 2 is inserted into the upper half of the casting mould, a space 19 remaining between the wall of the casting mould and the vacuum interrupting chamber 2. The plastics body 16 is inserted into the lower half of the casting mould, a space 20 remaining between the wall of the casting mould and the plastics body 16, too. The spaces 19, 20 between the casting mould and the vacuum interrupting chamber or the plastics body are then cast with a casting compound, for example an epoxy resin. As a result, the casting body 15 comprising the chamber 6 to be filled with insulating liquid is formed.

The upper plastics element 16A in the upper chamber half 6A comprises cutting edges 21 on the upper edge, which cut into a coating 3A of the housing 3 of the vacuum interrupting chamber 2 such that the casting compound, which has a relatively high viscosity in the liquid state, cannot enter a gap between the metal or ceramic housing 3 of the vacuum interrupting chamber 2 and the plastics element 16 when pressurised.

Once the casting compound has hardened, the moveable conductor part 12, the actuator 8, the insulating body 7 and the sealing arrangement 10 and, where necessary, additional components of the switching device are inserted into the cavity that is surrounded by the plastics part, and the cavity is filled with the insulating liquid. The cavity is then closed in a liquid-tight manner by fitting the cover 13.

1. High-voltage switching device, comprising a housing body (1), in which a vacuum interrupting chamber (2) is provided that comprises an immoveable switching contact element (4) and a switching contact element (5) that can move in the axial direction, the moveable switching contact element (5) extending out of the vacuum interrupting chamber (2) and being connected to an actuator (8), which can move in the axial direction, by means of an insulating body (7), and conductor parts (12, 13, 14) that form the current path being connected to the immoveable switching contact element (4) and the moveable switching contact element (5), characterised in that a cavity (22) that is filled with insulating liquid is made in the housing body (1), the moveable switching contact element (5) extending out of the vacuum interrupting chamber (2) and into the cavity (22), and in that the actuator (8) extends out of the cavity (22), a sealing arrangement (10) that is arranged in the cavity (22) being provided, which seals the actuator (8) with respect to the housing body (1).

2. High-voltage switching device according to claim 1, characterised in that the sealing arrangement (10) comprises a bellows (11) that is arranged in the cavity (22) and surrounds the actuator (8), one end of the bellows (11) being sealed with respect to the actuator (8) and the other end of the bellows being sealed with respect to the housing body (1).

3. High-voltage switching device according to claim 2, characterised in that the cavity (22) is closed by means of a cover (13) that is sealed with respect to the housing body (1), one end of the bellows (11) being sealed with respect to the cover (13).

4. High-voltage switching device according to any of claims 1 to 3, characterised in that the housing body (1) comprises a plastics body (16) that surrounds the cavity (22) at least in part.

5. High-voltage switching device according to claim 4, characterised in that the plastics body (16) consists of a plurality of plastics elements (16A, 16B, 16C) that are interconnected.

6. High-voltage switching device according to claim 5, characterised in that the plastics body (16) comprises a cylindrical plastics element (16C), which surrounds the sealing arrangement (10) at least in part.

7. High-voltage switching device according to either claim 5 or claim 6, characterised in that the plastics body (16) comprises a first bowl-shaped plastics element (16A) and a second bowl-shaped plastics element (16B), the conductor parts (12, 13, 14) that form the current path comprising a moveable conductor part (12), which is electrically connected to the moveable contact element (5), the moveable conductor part (5) being arranged in the cavity (22) and being surrounded by the first and second plastics element (16A, 16B) at least in part.

8. High-voltage switching device according to any of claims 1 to 7, characterised in that the housing body (1) comprises a casting body (15), which receives the vacuum interrupting chamber (2) and the plastics body (16).

9. High-voltage switching device according to claim 8, characterised in that the plastics body (16) is sealed with respect to the vacuum interrupting chamber (2).

10. High-voltage switching device according to claim 9, characterised in that cutting edges (21) are provided on the plastics body (16), the vacuum interrupting chamber (2) comprising a housing (3) that is surrounded, at least in part, by a material (3A) into which the cutting edges (21) cut.

11. Switchgear comprising a high-voltage switching device according to any of claims 1 to 10.

12. Method for producing a high-voltage switching device, wherein the high-voltage switching device comprises:
a housing body (1), in which a vacuum interrupting chamber (2) is provided that comprises an immoveable switching contact element (4) and a switching contact element (5) that can move in the axial direction, wherein the moveable switching contact element (5) extends out of the vacuum interrupting chamber (2) and into a cavity (22) that is filled with an insulating liquid and is surrounded by a plastics body (16), and
an actuator (8), which can move in the axial direction and is connected to the moveable contact element (5) by means of an insulating body (7), and a sealing arrangement (10) that is arranged in the cavity (22) and seals the actuator (8), which extends out of the cavity (22),with respect to the housing body (1),
comprising the following method steps:
providing a casting mould,
placing the vacuum interrupting chamber (2) and the plastics body (16) in the casting mould,
casting the space (19) between the vacuum interrupting chamber (2) and the plastics body (16) with a casting compound in order to provide a casting body (15) that surrounds the vacuum interrupting chamber and the plastics body and in which a cavity (22) that is surrounded by the plastics body (16), at least in part, is made,
inserting the actuator (8) and the insulating body (7) and the sealing arrangement (10) into the cavity,
filling the cavity (22) with an insulating liquid, and
closing the cavity (22) by means of a cover (13) that is sealed with respect to the casting body (15) or the plastics body (16).

13. Method according to claim 12, characterised in that the plastics body (16) is composed of a plurality of plastics elements (16A, 16B, 16C) that are interconnected.

14. Method according to claim 13, characterised in that the plastics body (16) is composed of two bowl-shaped plastics elements (16A, 16B) and one cylindrical plastics element (16C).

15. Method according to any of claims 1 to 14, characterised in that the casting compound is an epoxy resin.
